(19) United States
(12) Patent Application Publication
(10) Pub. No.: US 2006/0110584 A1
(43) Pub. Date: May 25, 2006

(54) Treated foil wrapping and method of manufacture

(76) Inventors: Gary Mawby, Las Vegas, NV (US); Kenneth Kroll, Las Vegas, NV (US)

Correspondence Address: Morishita Law Firm, L.L.C., Suite 850, 3800 Howard Hughes Pkwy., Las Vegas, NV, 89109, US

(21) Appl. No.: 11/329,479

(22) Filed: Jan. 10, 2006

Related U.S. Application Data
(63) Continuation-in-part of application No. 11/044,151, filed on Jan. 26, 2005, now abandoned.
(60) Provisional application No. 60/539,375, filed on Jan. 26, 2004.

(51) Int. Cl. B44C 1/17

(52) U.S. Cl. 428/195.1

(57) ABSTRACT

A treated foil wrapping includes a foil sheet treated with at least one surface agent selected from, for example, a deodorant surface agent, a scented surface agent, and an antimicrobial surface agent. The surface of the foil sheet may be prepared to receive the surface agent. The surface agent may be applied directly to the foil sheet alone or in combination with other chemical compounds. Alternatively, the optional treatments may be applied to a ply that is laminated to the foil sheet. The treated foil sheet may be physically or chemically sealed.

### RELATED APPLICATION DATA

The present application is a continuation-in-part of U.S. patent application Ser. No. 11/044,151, entitled “Treated Foil Wrapping and Method of Manufacture,” filed Jan. 26, 2005 by Applicants herein, which, in turn, claimed the priority of U.S. Provisional Application Ser. No. 60/539,375, entitled “Treated Foil Wrapping and Method of Manufacture,” filed Jan. 26, 2004 by Applicants herein.

### FIELD OF THE INVENTION

The present invention relates to wrappings. Specifically, the present invention is a treated foil wrapping including optional antimicrobial treatment and scented or deodorant treatment.

### BACKGROUND OF THE INVENTION

Many different applications call for wrapping or otherwise containing something. However, many of these applications call for wrappings that may have scented, deodorant, or antimicrobial properties. There are, however, no wrappings that provide these properties.

For example, in disposing of cat litter it is necessary to contain the soiled litter and any moisture held therein after removal from the litter box for disposal. However, the prior art discloses no container or wrapping for holding cat litter as it is removed from the litter box and containing the cat litter for disposal. U.S. Pat. No. 4,171,680 discloses litter box liners that are moisture absorbent to prevent transmission of moisture through the liners. But, as one can appreciate, the liners do not contain the cat litter for disposal and the pressboard material is intended to absorb moisture rather than contain moisture.

There are a number of other devices in the prior art directed to pet waste containers. For example, U.S. Pat. No. 3,885,266 discloses a collapsed cardboard blank that can be folded to form a disposable container for pet waste. U.S. Pat. No. 4,155,581 similarly discloses a collapsed cardboard sheet that can be folded to form a scoop and dustpan for sweeping and carrying, among other things, pet waste. Neither of these devices, however, provide antimicrobial properties, moisture control, and deodorant or scent to remove or mask odors.

Another application that calls for wrappings is food. For food use, a wrapping would provide the desirable property of moisture containment. This, as well known, is the advantage of aluminum foil and plastic wrap over paper wrapping or the like. The drawback to conventional aluminum foil and plastic wrap is that they do not provide antimicrobial and scent properties. That is, it would also be desirable to provide antimicrobial properties to prevent spoilage and under some circumstances, such as in a food service or restaurant setting, enhance the smell of the food by providing scent properties in the wrapping. However, the prior art does not disclose a food wrapping with all these properties.

Therefore, it can be seen that there is a need in the art for a treated foil wrapping.

### SUMMARY OF THE INVENTION

The present invention is a treated foil wrapping and a method for treating a foil wrapping. A thin metal foil sheet is provided. While the thickness and material could vary depending upon the particular use, it is contemplated that the foil sheet is malleable and manually foldable. The foil sheet may be in the form of a continuous sheet or may be pre-cut. It is also contemplated that the foil sheet may include printing on its surface.

The foil sheet is treated with at least one surface agent. For example, the foil sheet may optionally be treated with antimicrobial agent. The antimicrobial agent may vary depending upon the specific use of the treated foil wrapping. The foil sheet may also optionally be treated with a scented or deodorant agent. Again, the specific scented or deodorant agent may vary depending upon the use of the treated foil wrapping.

The foil sheet may be treated in many different ways. For example, in one optional embodiment, the optional antimicrobial or optional scented or deodorant treatment may be applied, bonded, or adhered directly to the foil sheet. In the simplest form of such an optional embodiment, the optional treatments may be applied directly onto the foil sheet. In another form of such an optional embodiment, the optional treatments may be mixed with a bonding or adhesive agent and applied to the foil sheet.

In another form of such an optional embodiment, the optional treatments may be mixed with the inks that will be used to produce artistic renderings on the foil so the various scents that may be adopted, depending upon the use of the treated foil wrapping, can be graphically reinforced through the art that is printed on the foil surface. Orange inks would emit orange scents; green inks would emit lime scents; and the like.

In a further form of such an optional embodiment, the surface of the foil sheet may be prepared to receive the optional treatments. Such preparation may include chemical processes, such as treatment with an adhesive or bonding agent, or physical processes, such as rolling, electrodeposition, etching, or otherwise roughing the surface to receive the optional treatments. The optional treatments are then applied to the prepared surface.

In another form of such an optional embodiment, the optional treatments are applied to the surface of the foil sheet and then covered with a physical or chemical coating such as a polymer or sealer. Such a coating may optionally break down or dissolve upon use of the treated foil wrapping to release the optional treatments.

In yet another optional embodiment, the optional treatments may be applied to a separate ply that is laminated to the foil sheet. The separate ply could be metal foil, polymer, paper, or any other material that could be laminated to the foil sheet without interfering with the malleability and foldability of the foil sheet. The optional treatments may be applied to the separate ply in any manner previously described.

### BRIEF DESCRIPTION OF THE DRAWINGS

FIG. 1 is a top view of a treated foil wrapping according to an embodiment of the present invention;

FIG. 2 is magnified, cutaway side view of an embodiment of a treated foil wrapping taken along section line A-A of FIG. 1;

FIG. 3 is magnified, cutaway side view of an alternate embodiment of a treated foil wrapping taken along section line A-A of FIG. 1;

FIG. 4 is magnified, cutaway side view of an alternate embodiment of a treated foil wrapping taken along section line A-A of FIG. 1;

FIG. 5 is magnified, cutaway side view of an alternate embodiment of a treated foil wrapping taken along section line A-A of FIG. 1;

FIG. 6 is a flow chart of a method of manufacture according to an embodiment of the present invention.

### DESCRIPTION

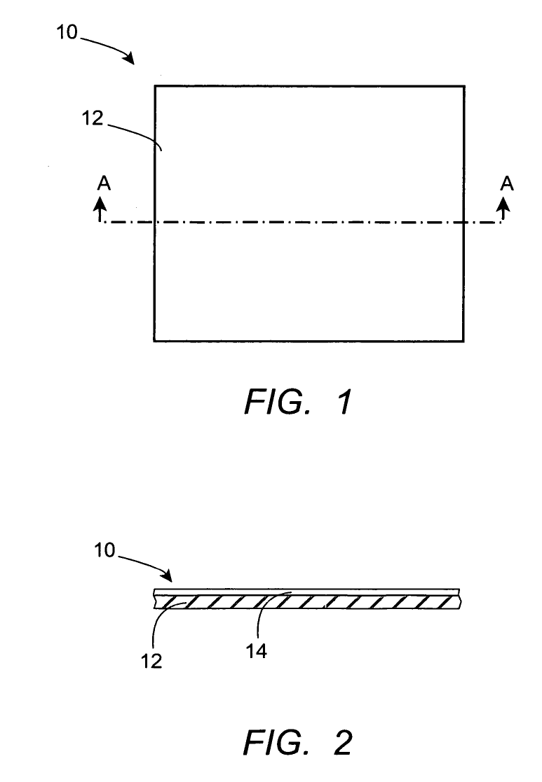

Reference is now made to the figures wherein like parts are referred to by like numerals throughout. Turning first to FIG. 1, the treated foil wrapping 10 of the present invention includes a foil sheet 12. The foil sheet 12 of the present invention is a thin metal material. While the precise thickness and type of metal could vary, it is contemplated that the foil sheet 12 would be a material with a thickness that would be malleable and manually foldable to function as a wrapping. For example, an aluminum foil of manually foldable thickness could be used.

The foil sheet 12 could take a variety of forms. Optionally, the foil sheet 12 is provided in continuous rolls and users could cut the sheet as needed. Alternatively, in an optional embodiment, the foil sheet 12 is pre-cut. It is also contemplated that the foil sheet 12 may include printing on its surface.

The foil sheet 12 is treated with one or more surface agents 14. That is, while the present invention specifically contemplates treatment with a surface agent selected from a antimicrobial surface agent, a scented surface agent, or a deodorant surface agent, it is contemplated that any particular use may call for only antimicrobial surface agent, only scented surface agent, only deodorant surface agent, or a combination of surface agents. Additionally, it is contemplated that other surface agents not specifically listed could be combined with any individual surface agent or combination thereof. For example, it is contemplated that the present invention may be used for a variety of purposes. These purposes include wrapping food products, wrapping pet waste, or wrapping any other type of product. In an optional embodiment for wrapping food products, the treated foil wrapping 10 may include only a scented treatment to enhance the scent of the food product or may include a combination of scented treatment, again to enhance the scent of the food product, as well as an antimicrobial treatment to inhibit bacterial, fungal, viral, or other antimicrobial growth. By contrast, in an optional embodiment for disposing of pet waste, such as pet feces or pet litter, the treated foil wrapping 10 may include a combination of scented treatment, deodorant treatment, and antimicrobial treatment; a combination of scented treatment and antimicrobial treatment; a combination of deodorant treatment and antimicrobial treatment; a combination of scented treatment and deodorant treatment; or only one of a scented treatment, deodorant treatment, or antimicrobial treatment. In short, it is contemplated that optional treatments used may vary according to the purpose of the treated foil wrapping 10. It is also noted that other surface agents 14 could be used and that the surface agents 14 could be mixed with other chemical compositions, such as preservatives, emulsifiers, stabilizers, buffers, or any other chemical composition, for any variety of purposes. For example, it is contemplated that the surface agents 14 may be encapsulated or suspended such that the optional treatments are time-released.

The surface agents 14 may be applied to the foil sheet 12 in a variety of ways. Referring first to FIG. 2, the surface agents 14 could optionally be applied directly to the surface of the foil sheet 12, such as by spraying the surface agents 14 onto the foil sheet 12. In a further optional embodiment, the surface agents 14 may be mixed with a bonding agent or adhesive to aid in holding the surface agents 14 to the foil sheet. It is noted that in manufacturing metal foils, the rolling process often results in a matte surface and a shiny surface. While the surface agents 14 could be applied to either surface, it is contemplated that the matte surface of the foil sheet 12 may receive the optional treatments better than the shiny surface under some circumstances.

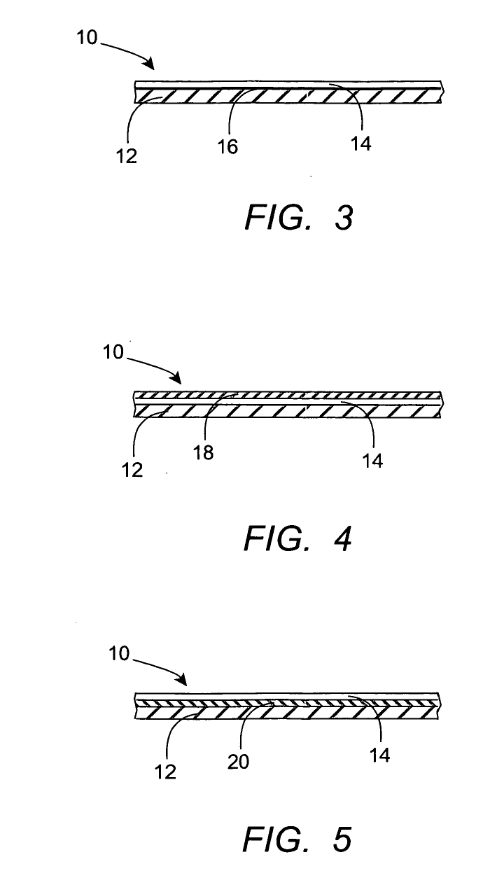

In an alternate optional embodiment, shown in FIG. 3, a surface of the foil sheet 12 may be prepared to receive the surface agents 14. The surface preparation may be a chemical preparation, a physical preparation, or a combination thereof. For example, the surface may be prepared chemically through the application of a bonding agent, such as an adhesive, to hold the surface agents 14 to the prepared surface 16. Similarly, the surface may be prepared physically by etching, rolling, or otherwise roughing the surface to provide a prepared surface 16 that is more able to receive and hold the surface agents 14. In a hybrid form of preparation, molecules may be electrodeposited onto the foil sheet 12 to provide a prepared surface 16 that will chemically and/or physically receive and hold the surface agents 14.

In yet another optional embodiment, shown in FIG. 4, surface agents 14 may be applied to the foil sheet 12 then covered with a physical or chemical sealing agent 18 to protect the surface agents 14 and hold the surface agents 14 to the foil sheet 12. In an optional embodiment in which the sealing agent 18 is physical, the sealing agent 18 could take many forms, including a polymer, optionally a thin polymer layer, overlying the surface agents 14. In an optional embodiment in which the sealing agent 18 is chemical, the sealing agent 18 could take many forms, including a chemical sealer overlying the surface agents 14. In such an optional embodiment, it is contemplated that the sealing agent 18 may be permit the surface agents 14 to pass or diffuse through the sealing agent 18. It is also contemplated that in an optional embodiment the sealing agent 18 may physically or chemically break down or dissolve over time, so as to give a time-release effect, or upon use to release the surface agents 14.

In yet another optional embodiment, shown in FIG. 5, the surface agents 14 may be applied to a ply 20 that is laminated to the foil sheet 12. The ply 20 could take any form including polymer, paper, metal foil, or the like, so long as the wrapping characteristics of the treated foil wrapper 10 are unaffected by the ply 20. The lamination may similarly take any form, including bonding, adhering, melting, or the like. The ply 20 may be treated with the optional treatments in any fashion appropriate for the type of ply material used, including direct application, application after surface preparation, application then coating, or any other method.

It is noted that in an optional embodiment, different surface treatments may be applied in different manners. Additionally, in an optional embodiment, the surface treatments may be combined with, or incorporated into, the printing. For example, in such an optional embodiment, a print area may include orange printing that includes an orange scent, green printing that includes a lime scent, and the like. In an optional embodiment including multiple print areas, this could enable the combination of different scents.

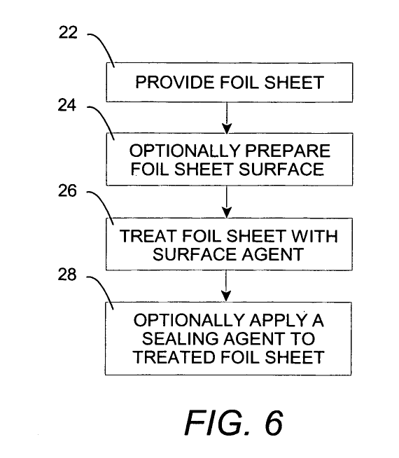

Referring generally to FIGS. 1-6, a method of manufacturing a treated foil wrapper 10 includes providing 22 a foil sheet 12. The surface of the foil sheet 12 may optionally be prepared 24 chemically or physically to create a prepared surface 16. The foil sheet 12 is treated 26 with surface agents 14, either directly or by applying the optional treatment to a ply 20 and laminating the ply 20 to the foil sheet. The surface agents 14 may be protected and held to the foil sheet 12 by optionally applying 28 a chemical or physical sealing agent 18 over the treated foil sheet.

While certain embodiments of the present invention have been shown and described it is to be understood that the present invention is subject to many modifications and changes without departing from the spirit and scope of the description presented herein.

I claim:

1. A foil wrapping comprising:
a metal foil sheet having a thickness such that the foil sheet is manually foldable; and
a surface agent on said foil sheet, the surface treatment selected from the group consisting of an antimicrobial agent, a scent agent, and a deodorant agent.

2. The foil wrapping of claim 1 wherein said surface agent is applied to said foil sheet directly.

3. The foil wrapping of claim 1 further comprising a bonding agent, said bonding agent combined with said surface agent and applied to said foil sheet.

4. The foil wrapping of claim 1 further comprising a sealing agent, said sealing agent applied to said surface agent.

5. The foil wrapping of claim 1 further comprising a ply, said surface agent applied to said ply and said ply laminated to said foil sheet.

6. The foil wrapping of claim 1 wherein said foil sheet includes printing on the surface thereof.

7. The foil wrapping of claim 6 wherein said surface agent is a scent agent and said printing incorporates said scent agent.

8. The foil wrapping of claim 6 wherein said printing includes at least a first print area and a second print area on said surface and wherein said surface agent includes at least a first scent agent and a second scent agent different from said first scent agent, said printing at said first print area incorporates said first scent agent said printing at said second print area incorporates said second scent agent.

9. An method of manufacturing a foil wrapping comprising:
forming a metal foil sheet having a thickness such that the foil sheet is manually foldable; and
treating said foil sheet with a surface agent on said foil sheet, the surface treatment selected from a group consisting of an antimicrobial agent, a scent agent, and a deodorant agent.

10. The method of claim 9 further comprising preparing at least one surface of said foil sheet by roughing said surface.

11. The method of claim 9 wherein said step of treating said foil sheet includes applying said surface agent directly to said foil sheet.

12. The method of claim 9 further comprising:
providing a bonding agent; and
preparing at least one surface of said foil sheet by applying said bonding agent to said surface prior to treating said foil sheet with said surface agent.

13. The method of claim 9 further comprising providing a bonding agent, wherein said step of treating said foil sheet includes combining said bonding agent with said surface agent and applying the combination of said bonding agent and said surface agent to said foil sheet.

14. The method of claim 9 further comprising:
providing a sealing agent;
applying said sealing agent to said surface agent after treating said foil sheet with said surface agent.

15. The method of claim 9 wherein said step of treating said foil sheet with said surface agent comprises:
providing a ply;
applying said surface agent to said ply; and
laminating said ply to said foil sheet.

16. The method of claim 9 further comprising printing on said foil sheet.

17. The method of claim 16 further comprising:
selecting a scent agent; and
incorporating said scent agent into said printing.

18. The method of claim 16 wherein said printing comprises at least a first print area and a second print area, the method further comprising:
selecting at least a first scent agent and a second scent agent different from said first scent agent; and
incorporating said first scent agent and said second scent agent into said printing such that said printing at said first print area incorporates said first scent agent said printing at said second print area incorporates said second scent agent.
